(19) United States
(12) Patent Application Publication
(10) Pub. No.: US 2010/0273622 A1
(43) Pub. Date: Oct. 28, 2010

(54) SPLIT VACUUM BAG

(75) Inventor: JOHN J. VONDERHAAR, SAINT JOSEPH, MI (US)

Correspondence Address: WHIRLPOOL PATENTS COMPANY - MD 0750, 500 RENAISSANCE DRIVE - SUITE 102, ST. JOSEPH, MI, 49085, US

(73) Assignee: WHIRLPOOL CORPORATION, BENTON HARBOR, MI (US)

(21) Appl. No.: 12/427,925

(22) Filed: Apr. 22, 2009

(51) Int. Cl. B31B 1/00; B65B 31/00

(52) U.S. Cl. 493/267; 53/512

(57) ABSTRACT

A storage bag includes a first flexible sheet and a second flexible sheet overlying and bonded to the first flexible sheet proximate a portion of an outer periphery of the first flexible sheet to form an open-mouthed bag having first and second sides. A first intermediate wall extends between and substantially across the first flexible sheet and the second flexible sheet. A first compartment is defined by the space between the first side of the open-mouthed bag and the intermediate wall. A second compartment is defined by the space between the second side of the open-mouthed bag and the intermediate wall.

### BACKGROUND OF THE PRESENT INVENTION

The present invention generally relates to a vacuum bag and, more specifically, to a split vacuum bag designed for use in heat-sealing applications.

### SUMMARY OF THE INVENTION

In one aspect of the present invention, a storage bag includes a first flexible sheet and a second flexible sheet overlying and bonded to the first flexible sheet proximate a portion of an outer periphery of the first flexible sheet to form an open-mouthed bag having first and second sides. A first intermediate wall extends between and substantially across the first flexible sheet and the second flexible sheet. A first compartment is defined by the space between the first side of the open-mouthed bag and the intermediate wall. A second compartment is defined by the space between the second side of the open-mouthed bag and the intermediate wall.

In another aspect of the present invention, a storage bag includes a first compartment having first, second, and third sides that are sealed and a fourth side that includes a closeable access opening. A second compartment is connected with and adjacent to the first compartment and having first, second, and third sides that are sealed and a fourth side that includes a closeable access opening. The first side of the second compartment is connected to the third side of the first compartment.

In yet another aspect of the present invention, a method of storing food includes forming a first sheet of flexible heat-sealable material. A second sheet is formed of flexible heat-sealable material. The first sheet is connected with the second sheet to form an open-mouthed bag. A first intermediate wall is formed between the first sheet and the second sheet in a middle portion of the open-mouthed bag. A first open-mouthed compartment is formed in the open-mouthed bag. A second open-mouthed compartment is formed in the open-mouthed bag. Food is inserted into the first open-mouthed compartment. Food is inserted into the second open-mouthed compartment.

These and other features, advantages, and objects of the present invention will be further understood and appreciated by those skilled in the art upon studying the following specification, claims, and appended drawings.

### BRIEF DESCRIPTION OF THE DRAWINGS

FIG. 1 is a top perspective view of one embodiment of a split vacuum bag of the present invention;

FIG. 2 is a top elevational cross-sectional view of the split vacuum bag taken at II-II of FIG. 1;

FIG. 3 is an enlarged cross-sectional view of the area III of FIG. 2;

FIG. 4 is a top perspective view of a split vacuum bag retaining food goods prior to vacuum sealing;

FIG. 5 is a top perspective view of the split vacuum bag of FIG. 4 during vacuum sealing;

FIG. 6 is a front elevational view of the split vacuum bag retaining food goods after vacuum sealing;

FIG. 7 is a cross-sectional elevational view of the split vacuum bag taken at VII-VII of FIG. 6;

FIG. 8 is an enlarged cross-sectional elevational view of the area VIII of FIG. 7;

FIG. 9 is a front elevational view of a portion of a roll of split vacuum bags prior to use;

FIG. 10 is another embodiment of a split vacuum bag of the present invention having three compartments;

FIG. 11 is a top perspective view of a three-compartment split vacuum bag after vacuum sealing;

FIG. 12 is a top cross-sectional elevational view taken at XII-XII of FIG. 11;

FIG. 13 is a front elevational view of a refrigerator having a removable vacuum sealing module for vacuum sealing a split vacuum bag; and

FIG. 14 is a front elevational view of the removable vacuum sealing module removed from the refrigerator and ready to vacuum seal split vacuum bags.

### DETAILED DESCRIPTION OF EMBODIMENTS

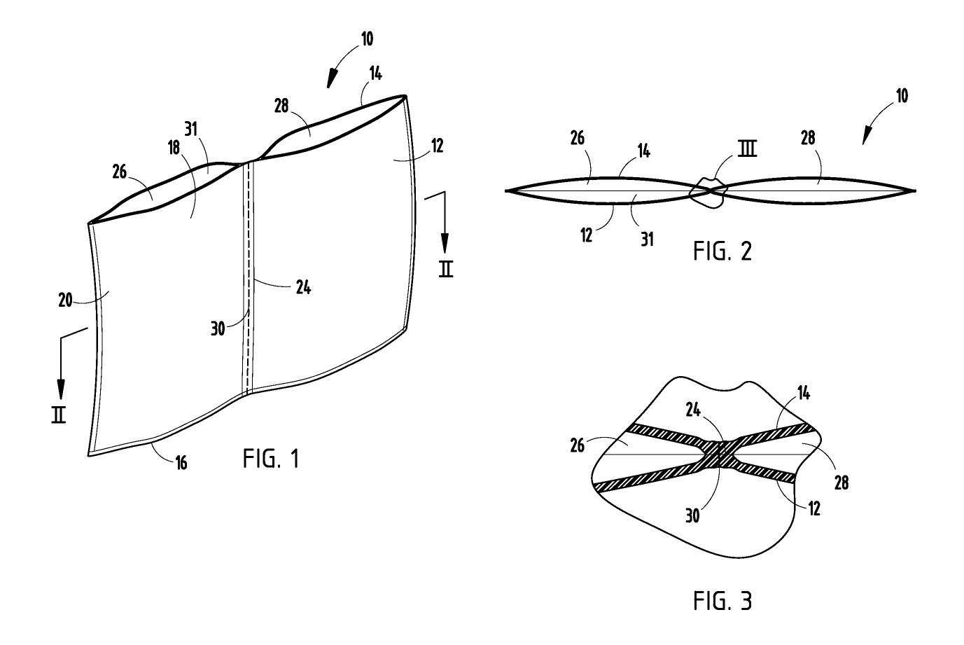

For purposes of description herein the terms “upper,” “lower,” “right,” “left,” “rear,” “front,” “vertical,” “horizontal” and derivatives thereof shall relate to the invention as oriented in FIG. 1. However, it is to be understood that the invention may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

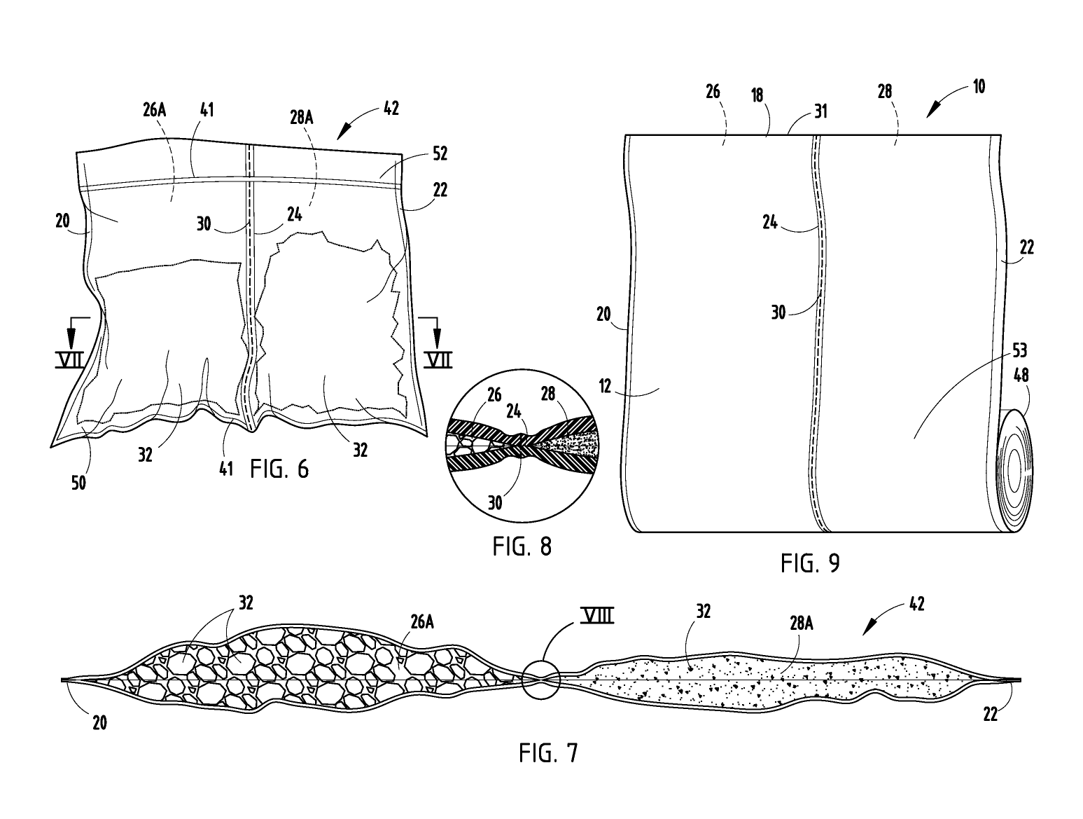

The reference numeral 10 shown in FIG. 1 generally designates a storage bag having a first flexible sheet 12 and a second flexible sheet 14 overlying and connected to the first flexible sheet 12 proximate an outer periphery 16 of the first flexible sheet 12 to form an open-mouthed bag 18 having first and second sides 20, 22 (FIG. 6). A first intermediate wall 24 extends between and substantially across the first flexible sheet 12 and the second flexible sheet 14. A first compartment 26 is defined by the space between the first side 20 of the open-mouthed bag 18 and the first intermediate wall 24. A second compartment 28 is defined by the space between the second side 22 of the open-mouthed bag 18 and the first intermediate wall 24.

Referring now to FIGS. 2 and 3, the storage bag or split vacuum bag 10 can be connected at the first intermediate wall 24 in a variety of ways. The first intermediate wall 24 is formed by heat-sealing, bonding, or adhering the first flexible sheet 12 to the second flexible sheet 14. In addition, the first intermediate wall 24 may include perforations 30 to allow separation of the first compartment 26 from the second compartment 28 by a user. The split vacuum bag 10 is generally constructed of heat-sealable material, such as a heat-sealable polymer, although other materials may be used.

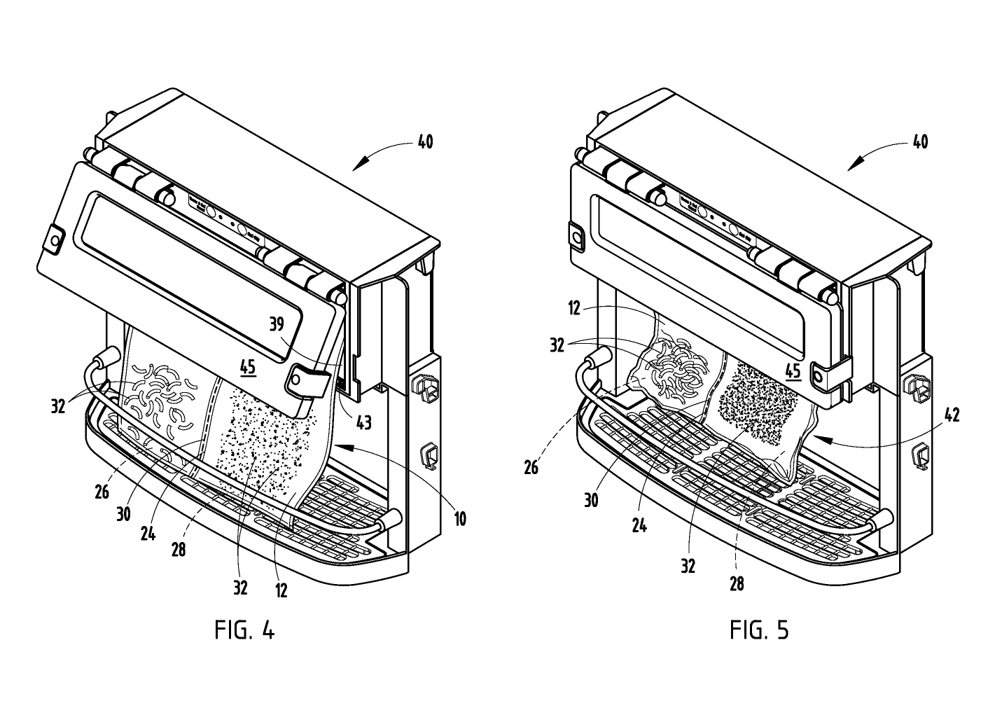

Referring now to FIGS. 4 and 5, the split vacuum bag 10 has a closeable access opening 31 (FIG. 1) designed to receive food goods 32 and be vacuum-sealed by a modular vacuum sealing component 40. After food goods 32 have been placed in the open-mouthed bag 18, the bag 18 is positioned such that the mouth of the bag 18 is adjacent to an air evacuation chamber 39 in the modular vacuum sealing component 40. The modular vacuum sealing component 40 includes a sealing door 45 that is operable between an open position and a closed position. The sealing door 45 closes over the closeable access opening 31 and a vacuum pump in the modular vacuum sealing component 40 is activated, which draws air from ports in the air evacuation chamber 39 and consequently from the bag 18. The modular vacuum sealing component 40 draws air from the first and second compartments 26, 28 of the open-mouthed bag 18, and after the first and second compartments 26, 28 have reached a predetermined vacuum pressure level, a sealing bar 43 is activated, which heat-seals the bag 18, leaving a heat seal 41 (FIG. 6), such that the mouth of the split vacuum bag 10 is sealed shut to form a sealed bag 42 with first and second sealed compartments 26A, 28A (FIG. 7). The sealed bag 42 is removed from the modular heat-sealing component 40 and stays at the vacuum pressure level inside the first and second sealed compartments 26A, 28A, thus preserving the food goods 32 inside the sealed bag 42, and minimizing excess air in the sealed bag 42, thereby increasing the longevity of the life of the food goods 32 and minimizing the chance of freezer burn.

Referring now to FIGS. 6-8, after the sealed bag 42 is removed from the modular vacuum sealing component 40, the food goods 32 are properly stored in their respective compartments 26, 28. As mentioned before, the first intermediate wall 24 may be perforated to allow for separation of the first compartment 26 from the second compartment 28.

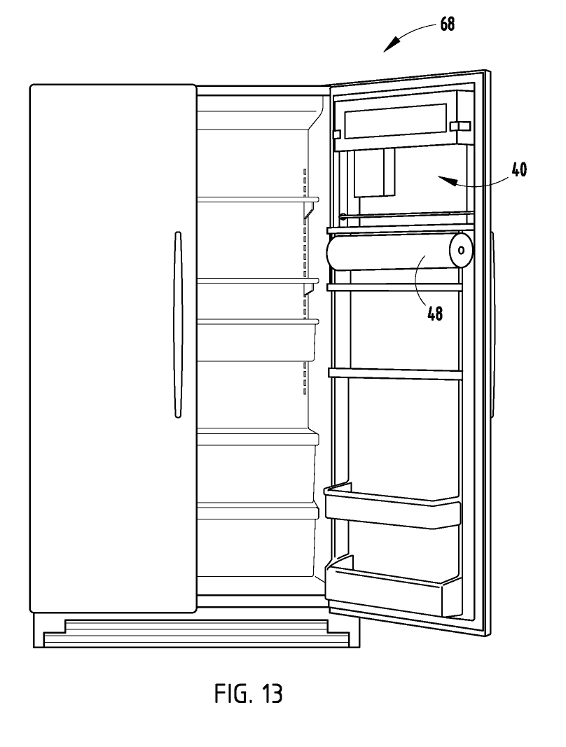

Referring now to FIGS. 6, 9 and 10, it is contemplated that the split vacuum bags 10 may be placed on a roll 48 (FIG. 13). In this instance, it is likely that the split vacuum bags will not be sealed at a top portion or a bottom portion thereof. Accordingly, the modular vacuum sealing component 40 will be needed to create the heat seal 41 at both a lower portion 50 and an upper portion 52 of the split vacuum bag 10. Additionally, perforations 30 may be positioned between adjacent bags 10 when on the roll 48. Alternatively, the split vacuum bags 10 may be connected to form a long sleeve 53 of sealable bags 10. In this case, the bags 10 are sealed and cut away from each other.

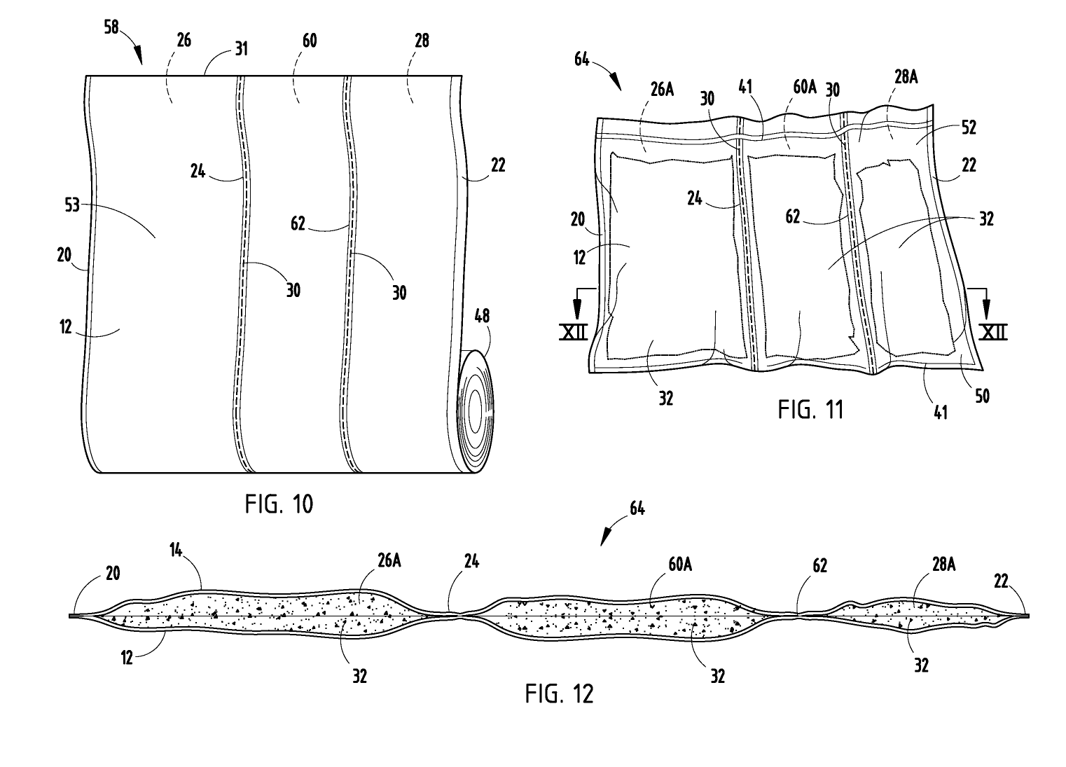

Referring now to FIGS. 11 and 12, in another embodiment of the present invention, a three-compartment split vacuum bag 58 (FIG. 10) having a third compartment 60 is provided to allow a third kind of food goods 32 to be added to the first and second food goods 32 in the first and second compartments 26, 28, respectively. The three-compartment split vacuum bag 58 operates in a similar manner to the two-compartment split vacuum bag 10, but allows for additional food goods to be separated from, yet stored with, complementary food goods.

The third compartment 60 is formed by the addition of a second intermediate wall 62 that extends between the first intermediate wall 24 and the second side 22 of the bag 18. The second intermediate wall 62 may include perforations 30 to allow separation of the third compartment 60 from the first and second compartments 26, 28. The three-compartment split vacuum bag 58 may be heat-sealed by the modular vacuum sealing component 40 in a similar manner to the two-compartment split vacuum bag 10 to form a sealed bag 64.

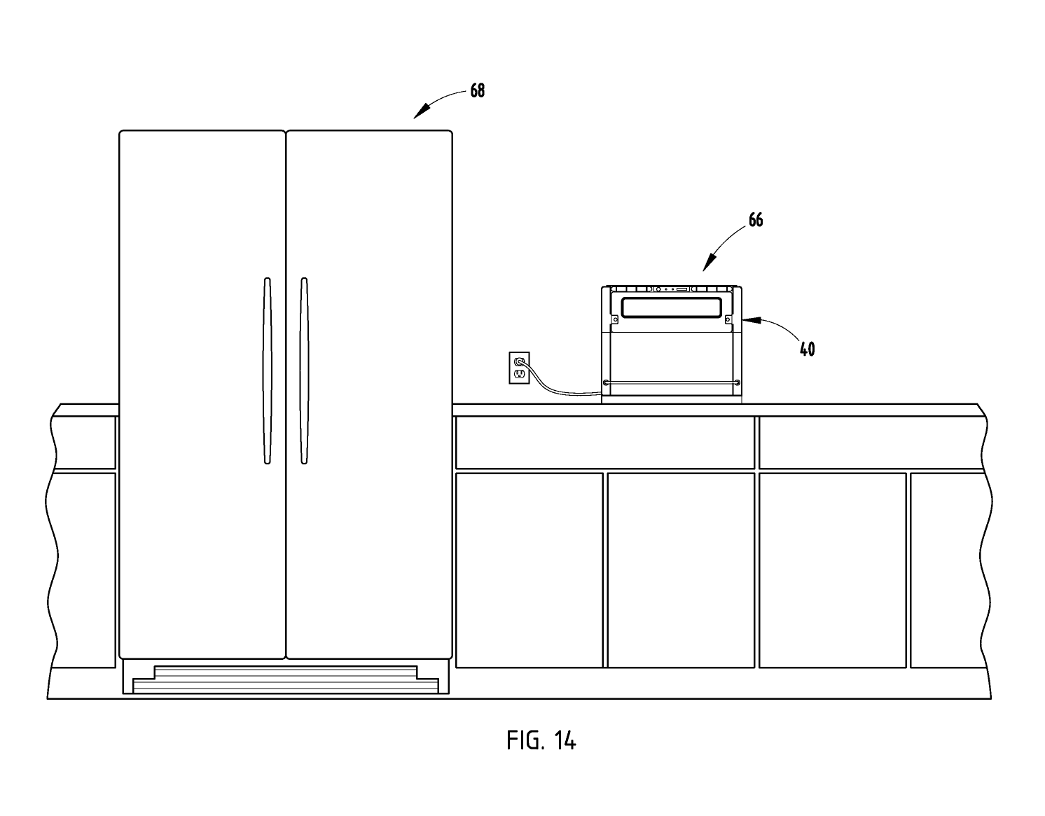

The modular vacuum sealing component 40 is designed for use as a stand-alone system 66 (FIG. 14), or may be installed in a refrigerated unit 68, as shown in FIG. 13. It is contemplated that the modular vacuum sealing component 40 can be installed in the refrigerator 68 and used, or removed from the refrigerator 68 and plugged into the wall or plugged into the refrigerator 68 to receive power to operate.

In one embodiment, a method of storing food includes forming the first flexible sheet 12 of flexible heat sealable material and forming the second flexible sheet 14 of flexible heat-sealable material. The first flexible sheet 12 is connected with the second flexible sheet 14 to form the open-mouthed bag 18. The first intermediate wall 24 is formed between the first flexible sheet 12 and the second flexible sheet 14 in the middle portion of the open-mouthed bag 18. The first open-mouthed compartment 26 and the second open-mouthed compartment 28 are formed in the open-mouthed bag 18. Food is inserted into the first open-mouthed compartment 26 and into the second open-mouthed compartment 28. After food has been inserted, air is vacuumed from the first and second open-mouthed compartments 26, 28. The first openmouthed compartment 26 and the second open-mouthed compartment 28 are sealed to form the first sealed compartment 26 and the second sealed compartment 28. The first intermediate wall 24 may have perforations 30. The second intermediate wall 62 may be formed between the first flexible sheet 12 and the second flexible sheet 14 in the middle portion of the open-mouthed bag 18. The second intermediate wall 62 may have perforations 30.

The above description is considered that of the preferred embodiments only. Modifications of the invention will occur to those skilled in the art and to those who make or use the invention. Therefore, it is understood that the embodiments shown in the drawings and described above is merely for illustrative purposes and not intended to limit the scope of the invention, which is defined by the following claims as interpreted according to the principles of patent law, including the Doctrine of Equivalents.

The invention claimed is:

1. A storage bag comprising:
a first flexible sheet;
a second flexible sheet overlying and bonded to the first flexible sheet proximate a portion of an outer periphery of the first flexible sheet to form an open-mouthed bag having first and second sides; and
a first intermediate wall extending between and substantially across the first flexible sheet and the second flexible sheet;
a first compartment defined by the space between the first side of the open-mouthed bag and the intermediate wall; and
a second compartment defined by the space between the second side of the open-mouthed bag and the intermediate wall.

2. The storage bag of claim 1, wherein the first intermediate wall is perforated.

3. The storage bag of claim 1, wherein the first flexible sheet and the second flexible sheet are constructed of a heat-sealable material.

4. The storage bag of claim 1, further comprising:
a second intermediate wall extending between and substantially across the first flexible sheet and the second flexible sheet; and
a third compartment defined by the space between the first intermediate wall and the second intermediate wall.

5. The storage bag of claim 4, wherein the second intermediate wall is perforated.

6. A storage bag comprising:
a first compartment having first, second, and third sides that are sealed and a fourth side that includes a closeable access opening; and
a second compartment connected with and adjacent to the first compartment and having first, second, and third sides that are sealed and a fourth side that includes a closeable access opening, wherein the first side of the second compartment is connected to the third side of the first compartment.

7. The storage bag of claim 6, further comprising:
a perforated wall extending between the first compartment and the second compartment.

8. The storage bag of claim 6, wherein the first compartment and the second compartment are made of a heat-sealable material.

9. The storage bag of claim 6, further comprising:
a third compartment connected with and adjacent to the second compartment.

10. The storage bag of claim 6, wherein at least a portion of the closeable access opening is heat-sealed.

11. A method of storing food, the method comprising:
forming a first sheet of flexible heat-sealable material;
forming a second sheet of flexible heat-sealable material;
connecting the first sheet with the second sheet to form an open-mouthed bag;
forming a first intermediate wall between the first sheet and the second sheet in a middle portion of the open-mouthed bag;
forming a first open-mouthed compartment in the open-mouthed bag;
forming a second open-mouthed compartment in the open-mouthed bag;
inserting food into the first open-mouthed compartment; and
inserting food into the second open-mouthed compartment.

12. The method of claim 11, further comprising:
vacuuming air from the first and second open-mouthed compartments.

13. The method of claim 12, further comprising:
Heat-sealing the first open-mouthed compartment to form a first sealed compartment.

14. The method of claim 13, further comprising:
Heat-sealing the second open-mouthed compartment to form a second sealed compartment.

15. The method of claim 11, further comprising:
perforating the first intermediate wall.

16. The method of claim 11, further comprising:
forming a second intermediate wall between the first sheet and the second sheet in the middle portion of the open-mouthed bag.

17. The method of claim 15, further comprising:
perforating the second intermediate wall.
